(19) United States
(12) Patent Application Publication
(10) Pub. No.: US 2004/0239618 A1
(43) Pub. Date: Dec. 2, 2004

(54) Method of inputing letters using mouse and its system

(76) Inventor: Han Sung Kim, Jamsil-7-dong (KR)

Correspondence Address: DAVID A. GUERRA, 933 OLANDER WAY SOUTH, SUITE 3, SOUTH PASADENA, FL, 33707, US

(21) Appl. No.: 10/487,564

(22) PCT Filed: Nov. 9, 2001
(86) PCT No.: PCT/KR01/01911

(30) Foreign Application Priority Data
Sep. 27, 2001 (KR) 2001/59917

(51) Int. Cl. G09G 5/00

(52) U.S. Cl. 345/156

(57) ABSTRACT

The present invention relates to a method of inputting letter using mouse and its system for inputting the letter using a mouth as well as using a keyboard. The letter input system using a mouse according to the present invention, in computer system having a set of means such as a mouse being a data input means, keyboard, and memory device storing, processing, and controlling received data, comprises i) a mouse control section which delivers the mouse cursor location information and click signal information to a meemory device and to a keyboard through a CPU, and ii) a keyboard processor which is built in a keyboard and produces the letter input signals from mouse clock signal information that the mouth control sector delivers through the CPU.

### TECHNICAL FIELD

The present invention relates to a system for inputting characters in a computer, and more particularly to system and method for inputting characters in a computer using a mouse.

### BACKGROUND ART

Typically, a keyboard and a mouse serving as a data entry unit have been widely used in a computer system such that they are adapted to set up or execute a program of a controlled subject and are also adapted to enter arbitrary data in such a computer system.

FIG. 1 is an exemplary view illustrating a general computer system coupled to a mouse 101 and a keyboard 102. With reference to FIG. 1, a keyboard 102 and a mouse 101 serving as data entry units are coupled to a computer main frame 103 via signal lines 101a and 102a, respectively, and a program's execution result is displayed on a monitor 104 in the computer main frame 103.

Like above, such a data entry unit for a computer system is the keyboard 102 and the mouse 101. Following the current trend of rapid expansion of Internet use, such a data entry unit is shifting from the keyboard to the mouse.

In other words, most computer works other than word processing work and work for entering multiple characters have been performed using a mouse only. Particularly, most computer works other than work for entering simple characters such as an ID, a password, and a keyword can be performed using only a mouse under the Internet environment.

In conclusion, using a keyboard instead of a mouse to enter such simple characters in a computer system results in inconvenience to a user.

### DISCLOSURE OF THE INVENTION

Therefore, the present invention has been made for solving the above problems, and it is an object of the present invention to provide a system and method for inputting characters in a computer using a mouse, for enabling a user to input desired characters into a computer using a mouse as well as a keyboard.

In accordance with one aspect of the present invention, the above and other objects can be accomplished, for a computer system including a mouse, a keyboard serving as data entry units, and a main frame containing a series of means, such as a memory unit for storing data entered by the mouse and the keyboard and a Central Processing Unit (CPU) for calculating/controlling the data, by the provision of a system for inputting characters in the computer system using a mouse, comprising: a mouse controlling unit provided in the main frame for calculating mouse information generated by the motion of the mouse or a mouse click operation, and transmitting mouse cursor position information and mouse click signal information corresponding to the mouse information to the memory, and transmitting-the mouse click signal information to the keyboard via the CPU; and a keyboard processing unit provided in the keyboard, for generating a character entry signal upon receiving the mouse click signal information received from the mouse controlling unit via the CPU.

A method for inputting characters in a computer using a mouse, comprises: a) generating a series of mouse information by moving or clicking a mouse; b) storing the mouse information in a memory unit provided in a main frame; c) determining whether mouse cursor position information among the mouse information stored in the memory unit is outside of a range of coordinates corresponding to a display area of a monitor; d) if the mouse cursor position information is outside of the range of coordinates, determining whether there is mouse click signal information, in the mouse information; e) transmitting the mouse click signal information to a keyboard processing unit provided in a keyboard; and f) enabling the keyboard processing unit to generate a character entry code, transmitting character data corresponding to the character entry code to a CPU via a signal line, and displaying characters.

Preferably, in a situation which does not require entry of many characters, such as an internet environment like web, a system for inputting characters in a computer using a mouse of the present invention may perform a simple character entry operation using only a mouse.

### BRIEF DESCRIPTION OF THE DRAWINGS

FIG. 1 is an exemplary view illustrating the appearance of a general computer system coupled to a mouse and a keyboard.

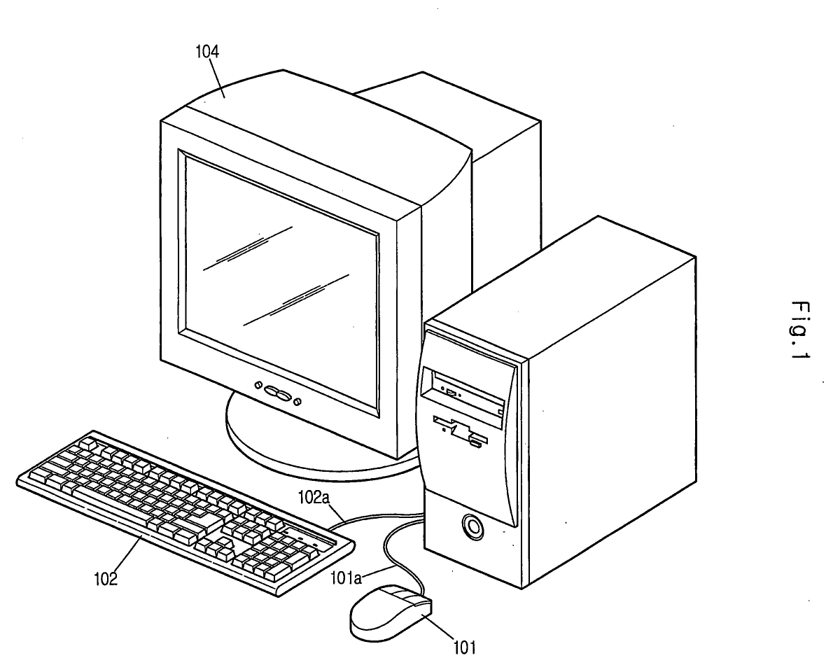

FIG. 2 is an exemplary view illustrating the appearance of a system for inputting characters in a computer using a mouse in accordance with the present invention.

FIG. 3 is a partially enlarged view illustrating a dotted-line block A shown in FIG. 2.

FIG. 4 is a view illustrating a block diagram of a system for inputting characters in a computer using a mouse in accordance with the present invention.

FIG. 5 is a flow chart illustrating a method for inputting characters in a computer using a mouse in accordance with the present invention.

### BEST MODE FOR CARRYING OUT THE INVENTION

Prior to the description of the present invention, the implementation principle of this present invention will hereinafter be briefly described.

If a mouse serving as a pointing device is moved, a mouse cursor also moves on a monitor. If the mouse cursor is moved below the lowest part of monitor, the mouse cursor disappears from the monitor screen. Light Emitting Diodes (LEDs) mounted in keytops of a keyboard emit light in response to the motion of the mouse. In this case, if an arbitrary keytop for emitting light is clicked by a mouse, a character or mark corresponding to the keytop is displayed on the monitor screen.

A system and method for inputting characters in a computer in accordance with the present invention will be described in detail with reference to the attached drawings.

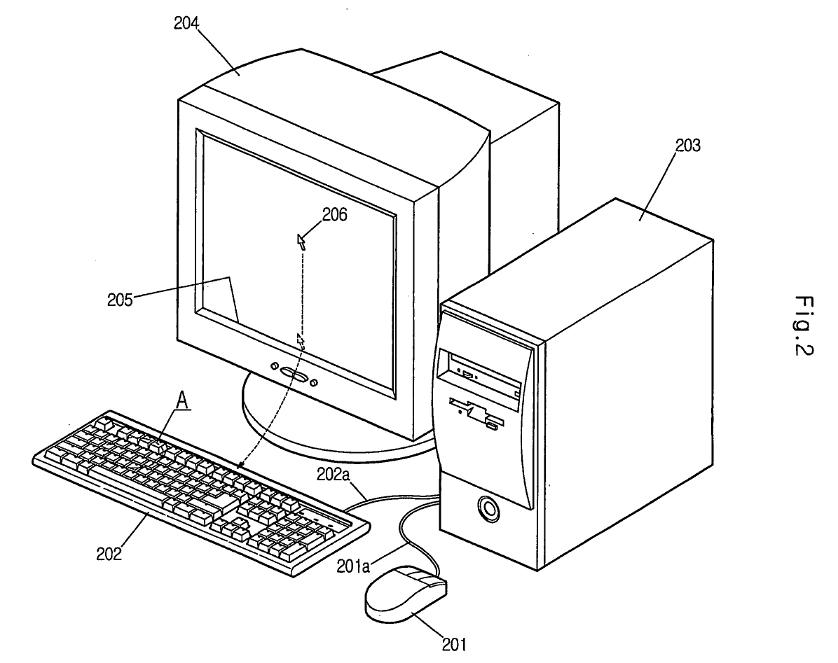

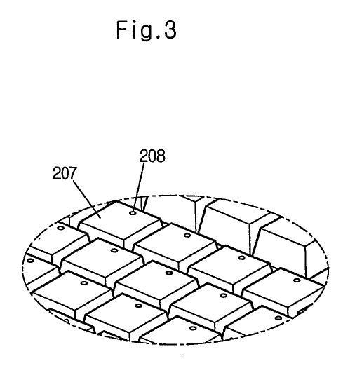

FIG. 2 is an exemplary view illustrating the appearance of a system for inputting characters in a computer using a mouse in accordance with the present invention, and FIG. 3 is a partially enlarged view illustrating a dotted-line block A shown in FIG. 2.

With reference to FIGS. 2 and 3, a system for inputting characters in a computer using a mouse comprises a computer main frame 203 mounting requisite hardware therein, a mouse 201 and a keyboard 202 for entering data in the computer main frame 203, and a monitor 204 for displaying the entered data thereon. Herein, a plurality of keytops 207 pushed by a user, on which individual characters and marks are printed, are positioned on the keyboard 202. An LED 208 is mounted in each keytop 207.

In this way, a mouse cursor 206 moves on a monitor if the mouse 201 is moved. In the case where the mouse cursor 206 moves down to the bottom horizontal line 205, it remains on the bottom horizontal line 205 on a monitor of the related art such that it does not disappear from the monitor screen. However, in case of the present invention, if the mouse cursor 206 moves below the bottom horizontal line 205, it disappears from the monitor screen, but a keyboard position corresponding to moving coordinates of the mouse emits light. In more detail, an LED mounted in each keytop of a keyboard emits light. Therefore, a user can select his or her desired keytop by moving a mouse, and an appropriate character corresponding to a keytop clicked by the mouse is displayed on a monitor.

Comparing the principle of the present invention with that of the related art, the present invention extends a motion range of a mouse cursor to a keyboard area as well as a monitor screen, whereas a motion range of a mouse cursor of the related art has been limited on a monitor screen.

Prior to the detailed description of the present invention, a general method for entering characters using a keyboard will hereinafter be described.

For the convenience of description, an internal configuration of such a keyboard will be omitted below.

If a user pushes a keytop indicating a character thereon using his or her finger, a membrane positioned under the keytop moves down. As the membrane moves down by the pushed keytop, an electric signal is applied to three sheets provided under the membrane along a conductive line, and is transmitted to a flat cable integrated with the sheets as one body. Then, the electric signal is transmitted to a keyboard processing unit provided in a keyboard, and the keyboard processing unit generates a character entry code corresponding to the electric signal to inform a computer's CPU of the character entry code, thereby displaying a corresponding character on a monitor screen.

The most important device in the aforesaid character entry method is the keyboard processing unit for generating a character entry code and commanding a monitor to display a corresponding character thereon.

The present invention is focused on the aforementioned important device, and its subject aims at a character entry procedure for inputting characters by operating the keyboard processing unit using a mouse.

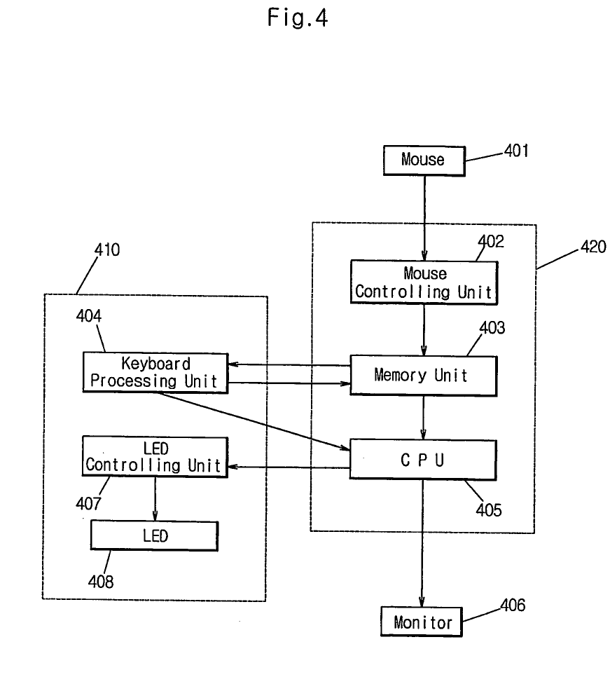

FIG. 4 is a flow chart illustrating a method for inputting characters in a computer using a mouse in accordance with the present invention.

With reference to FIG. 4, a system according to the present invention comprises a mouse 401 serving as a pointing device, a main frame unit 420 for storing, operating and processing a series of mouse information produced by the mouse 401, a keyboard unit 410 for generating a character entry code by receiving the mouse information of the main frame unit 420, and controlling a light-emitting operation of an LED, and a monitor for displaying characters on the basis of character entry codes produced by the keyboard unit 410.

The main frame unit 420 includes a mouse controlling unit 402 for calculating mouse information generated by the motion of the mouse 401 or a mouse click operation, transmitting mouse cursor position information and mouse click signal information corresponding to the mouse information to a memory unit 403, and transmitting the mouse click signal information to a keyboard unit via a CPU 405. The main frame unit 420 further includes a memory unit 403 for storing the mouse information therein, and a CPU 405 for processing the mouse information.

The keyboard unit 410 includes a keyboard processing unit 404 for generating a character entry code by mouse information received via the CPU 405, an LED 408 mounted in each keytop of the keyboard, and an LED controlling unit 407 for controlling the LED 408. The LED controlling unit 407 is controlled by a command of the CPU 405 on the basis of the mouse information stored in the memory unit 403.

The CPU 405 receives the character entry code data generated by the keyboard processing unit 404, and then displays an appropriate character corresponding to the received entry code data.

A method for operating the aforementioned system for inputting characters using such a mouse will hereinafter be described.

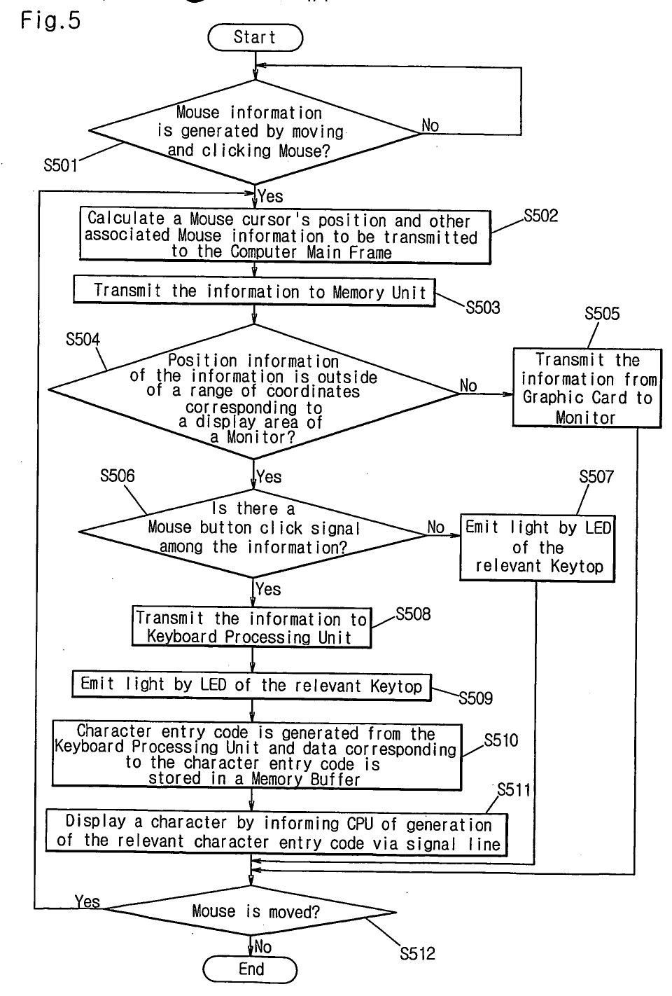

FIG. 5 is a flow chart illustrating a method for inputting characters in a computer using a mouse in accordance with the present invention.

With reference to FIG. 5, if a user moves a mouse 401, a mouse motion signal and a mouse button click signal are generated by a plurality of internal components of the mouse (S501).

The mouse information generated from the internal components of the mouse is transmitted to a mouse controlling unit 402 of a main frame. So, the mouse controlling unit calculates the distance of mouse motion and a mouse click signal, and thus calculates a mouse cursor's position and other associated mouse information to be transmitted to the computer main frame on the basis of the calculated result (S502).

Thereafter, the mouse information is transmitted to a memory unit 403 (S503).

The mouse information transmitted to the memory unit 403 through the above steps is analyzed by a CPU 405. This analysis step will hereinafter be described in detail.

First, it is determined at step S504 whether position information of a mouse cursor among the plurality of mouse information received at a memory unit is positioned in a corresponding coordinates on a monitor (S504).

If it is determined at step S504 that the position information of the mouse cursor is the coordinates positioned in a monitor, this means a general motion of mouse on a monitor, and mouse cursor position information corresponding to the coordinates is transmitted to the monitor via a graphic card (S505).

On the other hand, if the mouse cursor position information is outside of the corresponding coordinates on a monitor, this means that the mouse cursor is positioned on a keyboard area as previously stated in the implementation principle of the present invention.

After recognizing the mouse cursor position information, it is determined whether a mouse click signal is contained in the mouse information (S506). Herein, the mouse click signal is generated by user's pushing keytop of keyboard. Assuming that a mouse cursor position is outside of a display range of the monitor, that is, a mouse motion position is positioned on a keyboard, it is determined whether a signal is applied to an arbitrary keytop on the keyboard (S506).

In this case, if there is no mouse click signal in the mouse information, it means that a user sets a mouse motion position on a keyboard but does not select a specific keytop corresponding to the mouse motion position. Then, an LED 408 mounted in such a specific keytop corresponding to the mouse motion position emits light (S507). Here, the LED is controlled by the LED controlling unit 407.

In the meantime, if a mouse click signal exists in the mouse information, it is transmitted to a keyboard processing unit 404 provided in a keyboard (S508).

In the meantime, if a mouse click signal exists in the mouse information, it is transmitted to a keyboard processing unit 404 provided in a keyboard (S508).

Comparing the step S508 with the related art method, an electric signal corresponding to a specific keytop pushed by a user is transmitted to the keyboard processing unit 404 via a plurality of procedures in the related art, but the mouse click signal of the step S508 according to the present invention corresponds to the above electric signal of the related art such that the present invention performs a character entry operation by a mouse click signal corresponding to the electric signal of the related art.

Also, mouse click information is transmitted to the keyboard processing unit and an LED of the specific keytop emits light at the same time (S509). In the same manner as the step S507, the LED is controlled by the LED controlling unit 407.

As described above, the mouse click signal transmitted to the keyboard processing unit enables the keyboard processing unit to generate a specific character entry code, and then data corresponding to the specific character entry code is stored in a memory buffer (S510).

Thereafter, the data stored in the memory buffer, i.e., character information, is transmitted to a CPU 405 of a main frame unit via a signal line of a keyboard such that a corresponding character is displayed on a monitor (S511).

Mouse click information is transmitted to the keyboard processing unit and an LED of the specific keytop emits light at the same time (S509). In the same manner as the step S507, the LED is controlled by the LED controlling unit 407. As described above, the mouse click signal transmitted to the keyboard processing unit enables the keyboard processing unit to generate a specific character entry code, and then data corresponding to the specific character entry code is stored in a memory buffer (S510). Thereafter, the data stored in the memory buffer, i.e., character information, is transmitted to a CPU 405 of a main frame unit via a signal line of a keyboard such that a corresponding character is displayed on a monitor (S511).

### Industrial Applicability

As apparent from the above description, the system and method for inputting characters using a mouse provides the following advantages.

In a situation which does not require entry of many characters, such as an internet environment like web, a system for inputting characters in a computer using a mouse of the present invention may perform a simple character entry operation using only a mouse.

Also, a function for automatically completing a word, i.e., a function for automatically completing similar words when a user enters a few characters, is currently supported by a plurality of software programs. Therefore, the present invention enables a user to easily input similar words or sentences when the user inputs a few characters using a mouse. Thus, the effect of the present invention is multiplied.

What is claimed is:

1. A system for inputting characters in the computer system using a mouse, for a computer system including a mouse, a keyboard serving as data entry units, and a main frame containing a series of means, such as a memory unit for storing data entered by the mouse and the keyboard and a Central Processing Unit (CPU) for calculating/controlling the data, comprising:
a mouse controlling unit provided in the main frame for calculating mouse information generated by the motion of the mouse or a mouse click operation, and transmitting mouse cursor position information and mouse click signal information corresponding to the mouse information to the memory, and transmitting the mouse click signal information to the keyboard via the CPU; and
a keyboard processing unit provided in the keyboard, for generating a character entry signal upon receiving the mouse click signal information received from the mouse controlling unit via the CPU.

2. The system of claim 1, wherein the keyboard further includes:
an LED mounted in each keytop on the keyboard, for emitting light upon receiving the mouse cursor position information stored in the memory unit; and
an LED controlling unit for directly controlling the LED upon receiving a command from the CPU.

3. A method for inputting characters in a computer using a mouse, comprising:
a) generating a series of mouse information by moving or clicking a mouse;
b) storing the mouse information in a memory unit provided in a main frame;
c) determining whether mouse cursor position information among the mouse information stored in the memory unit is outside of a range of coordinates corresponding to a display area of a monitor;
d) if the mouse cursor position information is outside of the range of coordinates, determining whether there is mouse click signal information, in the mouse information;
e) transmitting the mouse click signal information to a keyboard processing unit provided in a keyboard; and
f) enabling the keyboard processing unit to generate a character entry code, transmitting character data corresponding to the character entry code to a CPU via a signal line, and displaying characters.

4. The method of claim 3, if it is determined that mouse position information among the mouse information stored in the memory unit is outside of the range of coordinates corresponding to a display area of a monitor, wherein an LED mounted in a keytop on the keyboard emits light by an LED controlling unit controlled by a command of the CPU.
